(19) United States
(12) Patent Application Publication
(10) Pub. No.: US 2024/0292435 A1
(43) Pub. Date: Aug. 29, 2024

(54) CHANNEL ANNOUNCEMENT IN WIRELESS COMMUNICATION SYSTEMS

(71) Applicant: Samsung Electronics Co., Ltd., Suwon-si (KR)

(72) Inventors: Rubayet Shafin, Allen, TX (US); Boon Loong Ng, Plano, TX (US); Vishnu Vardhan Ratnam, Plano, TX (US); Peshal Nayak, Plano, TX (US); Yue Qi, Plano, TX (US)

(21) Appl. No.: 18/414,382

(22) Filed: Jan. 16, 2024

Related U.S. Application Data
(60) Provisional application No. 63/448,161, filed on Feb. 24, 2023.

(51) Int. Cl. H04W 72/40; H04W 72/02

(52) U.S. Cl. CPC H04W 72/40; H04W 72/02; H04W 84/12

(57) ABSTRACT

A wireless communication network includes an access point (AP) device and a non-AP device. The AP device may advertise a frame indicating a recommended channel for peer-to-peer communication. The non-AP device may perform peer-to-peer communication with one or more other non-AP devices using the recommended channel. The frame may be a beacon frame or a probe response frame.

### CROSS-REFERENCE TO RELATED APPLICATIONS

This application claims the benefit of priority from U.S. Provisional Application No. 63/448,161, entitled “METHOD AND APPARATUS FOR PEER-TO-PEER CHANNEL ANNOUNCEMENT FOR WLAN NETWORKS,” filed Feb. 24, 2023, which is incorporated herein by reference in its entirety.

### TECHNICAL FIELD

This disclosure relates generally to a wireless communication system, and more particularly to, for example, but not limited to, channel announcement in wireless communication systems.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of this disclosure provides an AP device in a wireless network. The AP device comprises a memory, and a processor coupled to the memory. The processor is configured to generate a frame indicating one or more recommended channels for peer-to-peer communication. The processor is configured to transmit the frame to one or more non-AP devices.

In some embodiments, the frame is a beacon frame or a probe response frame.

In some embodiments, the frame includes a channel usage element for the one or more recommended channels.

In some embodiments, the channel usage element includes a usage mode field indicating a usage of the one or more recommended channels.

In some embodiments, the channel usage element includes one or more channel numbers and one or more operating classes for the one or more recommended channels.

In some embodiments, a non-AP device among the one or more non-AP device is unassociated with the AP device.

In some embodiments, the frame includes a power constraint element indicating a maximum transmit power for a receiving non-AP device.

In some embodiments, the frame includes an enhanced distributed channel Access (EDCA) parameter set element indicating EDCA parameters for transmission for a receiving non-AP device.

In some embodiments, the one or more recommended channels are within a set of channels used by the AP device for infrastructure basic service set.

In some embodiments, the one or more recommended channels are outside a set of channels used by the AP device for infrastructure basic service set.

One aspect of this disclosure provides a non-AP device in a wireless network. The non-AP device comprises a memory, and a processor coupled to the memory. The processor is configured to receive a frame indicating one or more recommended channels for peer-to-peer communication from an AP device. The processor is configured to select a channel among the one or more recommended channels for peer-to-peer communication based on the received frame. The processor is configured to perform peer-to-peer communication with one or more other non-AP devices using the selected channel.

In some embodiments, wherein the frame is a beacon frame or a probe response frame.

In some embodiments, the frame includes a channel usage element for the one or more recommended channels.

In some embodiments, the channel usage element includes a usage mode field indicating a usage of the one or more recommended channels.

In some embodiments, the channel usage element includes one or more channel numbers and one or more operating classes for the one or more recommended channels.

In some embodiments, the AP device is unassociated with the non-AP device.

In some embodiments, the frame includes a power constraint element, and the processor is further configured to determine a maximum transmit power based on the power constraint element.

In some embodiments, the frame includes an enhanced distributed channel Access (EDCA) parameter set element, and the processor is further configured to determine EDCA parameters for transmission based on the EDCA parameter element.

In some embodiments, the one or more recommended channels are within a set of channels used by the AP device for infrastructure basic service set.

In some embodiments, the one or more recommended channels are outside a set of channels used by the AP device for infrastructure basic service set.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example network in accordance with an embodiment.

FIG. 5 shows an example of recommended P2P channels in accordance with an embodiment.

FIG. 6 shows another example of recommended P2P channels in accordance with an embodiment.

FIG. 7 shows an example of Recommended P2P Channel Usage Info element in accordance with an embodiment.

FIG. 8 shows another example format of the Channel Info field in a Channel Usage Information subelement in accordance with an embodiment.

FIG. 9 shows a flow chart of an example process for channel recommendation in accordance with an embodiment.

FIG. 10 shows a flow chart of an example process for channel recommendation in accordance with an embodiment.

FIG. 11 shows a flow chart of an example process for channel recommendation procedure in accordance with an embodiment.

FIG. 12 shows another example of Recommended P2P Channel Usage Info element in accordance with an embodiment.

FIG. 13 shows another example of Recommended P2P Channel Usage Info element in accordance with an embodiment.

FIGS. 14 and 15 show another example of Recommended P2P Channel Usage Info element in accordance with an embodiment.

FIG. 16 shows another example of Recommended P2P Channel Usage Info element in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11bc standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11bc. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

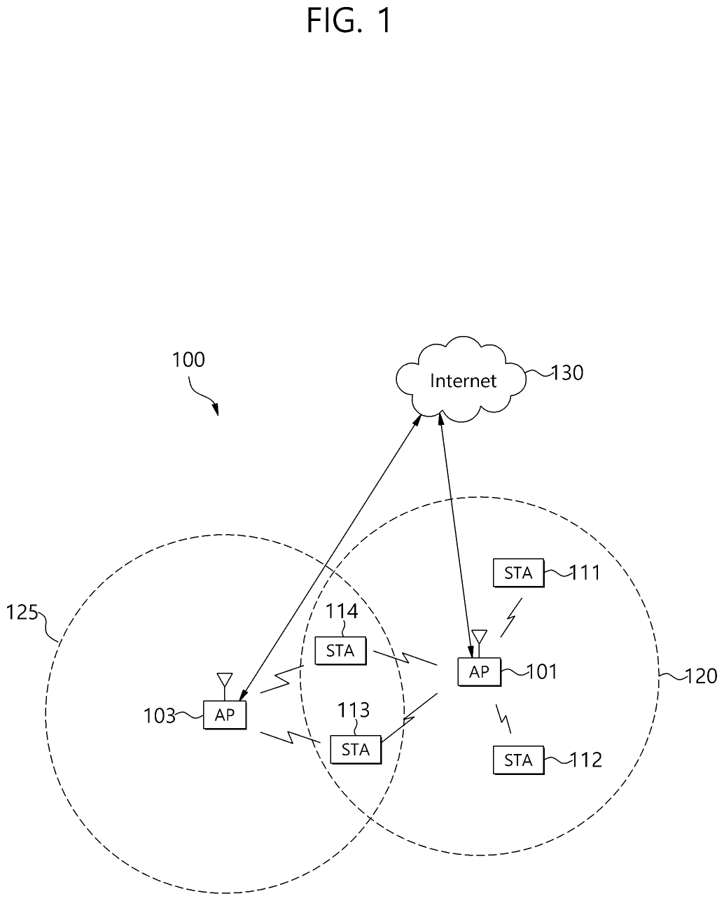

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs.

Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

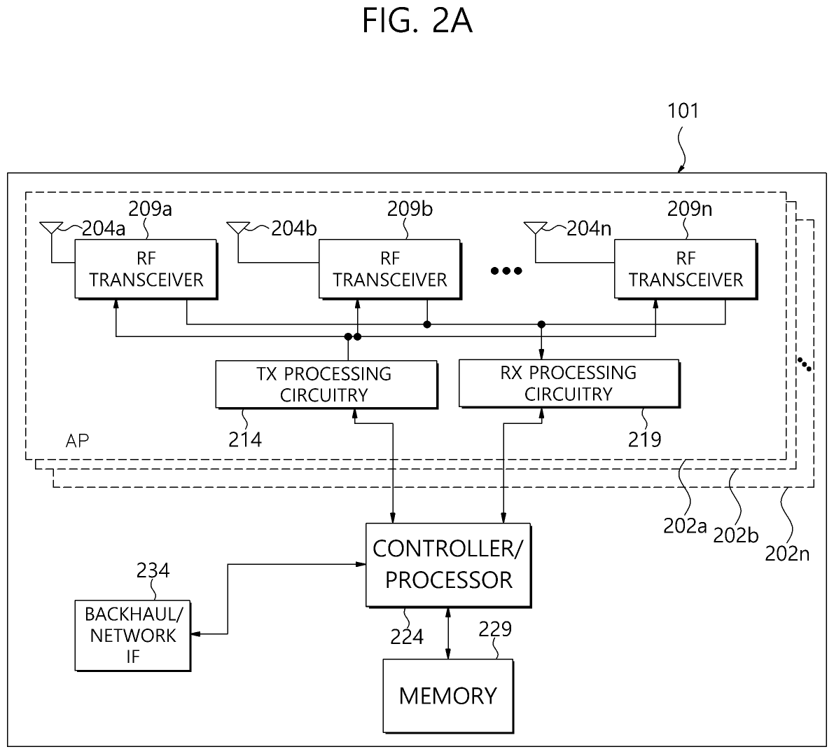

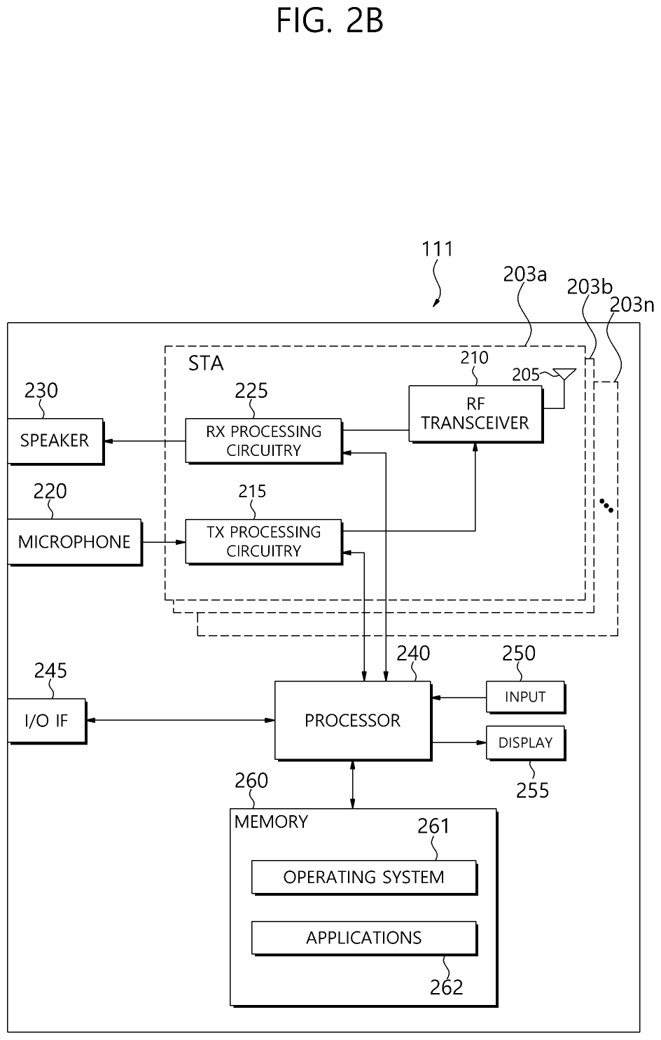

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

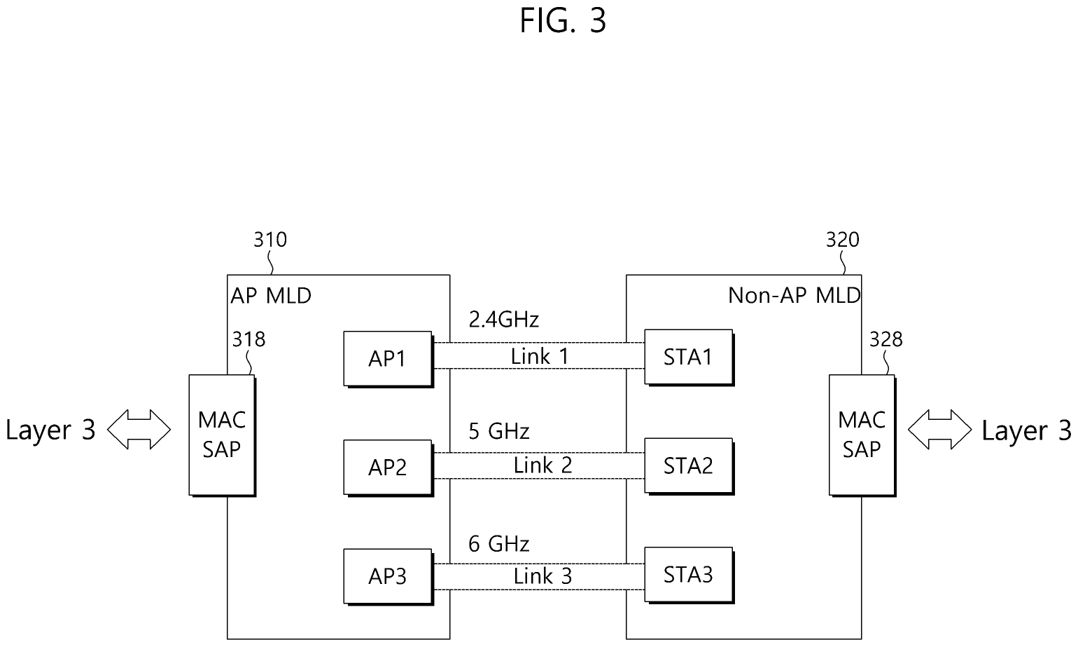

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

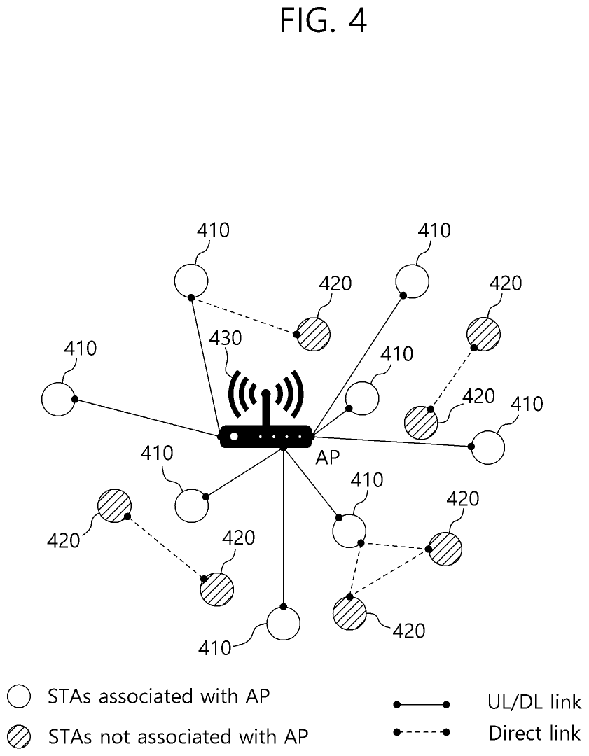

FIG. 4 shows an example network in accordance with an embodiment. The network depicted in FIG. 4 is for explanatory and illustration purposes. FIG. 4 does not limit the scope of this disclosure to any particular implementation.

In FIG. 4, STAs 410 are non-AP stations associated with AP 430, and STAs 420 are non-AP stations which are not associated with the AP 430. Additionally, solid lines between stations represent uplink or downlink with AP 430, while the dashed lines between stations represent a direct link.

Next generation WLAN system needs to provide improved support for low-latency applications. Today, it is not uncommon to observe numerous devices operating on the same network. Many of these devices may have a tolerance for latency, but still compete or contend with the devices running low-latency applications for the same time and frequency resources. In some cases, the AP as a network controller may not have enough control over the unregulated or unmanaged traffic that contends with the low-latency traffic within the infrastructure BSS (Basic Service Set). In some embodiments, the infrastructure BSS is a basic service set that includes a AP and one or more non-APs, while independent BSS is a basic service set where stations communicates with each other without the need for a centralized AP. Some of the unregulated or unmanaged traffic that interferes with the latency-sensitive traffic in the AP's BSS may originate from uplink, downlink, or direct link communications within the infrastructure BSS that the AP manages. Another source of the interference may be transmission from the neighboring infrastructure OBSS (Overlapping Basic Service Set), while others may come from neighboring independent BSS or P2P networks. Therefore, the next generation WLAN system needs mechanisms to more effectively handle the unmanaged traffic while prioritizing low-latency traffic in the network. In the WLAN network, if the STAs 410 and 420 within their network or neighboring networks use pre-determined or recommended channels for uplink, downlink, and direct link communications, it can significantly enhance the management of BSS traffic, thereby supporting latency-sensitive applications in the network. However, there is currently no such mechanism in place to address the issue.

This disclosure provides an improved mechanism for more efficiently managing traffic in the network. It also explains how the AP can allocate and announce channels for direct link and UL/DL communication. This allocation may help reduce interference on the low-latency traffic stemming from direct link communication and UL/DL link communication from its own BSS or OBSS.

In some embodiments, an AP may announce or advertise channels in its BSS that are recommended for peer-to-peer (P2P) communication. These channels may be considered more conducive to P2P communication than other available channels and may be referred to as ‘recommended P2P channels’ or ‘recommended channels’ in this disclosure.

In some embodiments, the AP may announce or advertise the recommended P2P channels in its BSS by including the relevant information in a beacon frame or a probe response frame. Additionally, a broadcast frame, a multicast frame, or a group-addressed frame may also be employed to announce the Recommended P2P Channels.

Assigning channels for P2P communications and grouping P2P transmissions into these recommended P2P Channels allows the AP to effectively reduce the uncontrolled interference from the channels used for infrastructure BSS operation, for instance, uplink/downlink communications. This may empower the AP to more effectively manage its network and ensure QoS requirement for STAs within its BSS. From the STA's perspective, if the STAs planning to establish an independent BSS (e.g., P2P group) or change their operating channel for P2P operation receive relevant information from the AP about the recommended channels for P2P or independent BSS operation, it is in their best interest to use these recommended channels. Using the recommended channels may reduce interference stemming from the infrastructure network. For instance, if a STA randomly selects a channel for initiating a P2P group, it may overlap with one of the channels used by the nearby AP for its BSS operation. Consequently, this random channel selection would encounter significantly more interference from the infrastructure network compared to the channels recommended by the AP for P2P communication.

In an embodiment, an AP that advertises a channel as a recommended P2P channel may ensure that the AP does not use the recommended P2P channel as the operating channel in its infrastructure BSS. This may generate an incentive for the non-AP STAs engaging in P2P communication to use the recommended channel since it will not be used for traffic delivery in the infrastructure network.

In an embodiment, an AP that advertises a channel as a recommended P2P channel may still use the channel for traffic delivery in the infrastructure network. However, the AP may attempt to minimize the transmission on the channel. In some implementations, the AP may ensure that only trigger-enabled transmissions are allowed on the recommended channel. In some implementations, the AP may use the recommended channel for latency-sensitive traffic or priority access traffic, such as national security or disaster management-related traffic. Other applications that restrict the use of the recommended channel are also possible. In an embodiment, an AP may not advertise a channel as a recommended P2P channel if the channel is used by DFS (dynamic frequency selection) or radar purpose.

In an embodiment, when an AP advertises a channel used for DFS or radar purpose as a recommended P2P channel and a non-AP STA uses the channel for P2P communication, the non-AP STA may ensure that the P2P communication does not cause interference with DFS or radar applications. In some implementations, the non-AP STA engaging in the P2P communication may employ lower-power communication, such as short-range communication, instead of the standard power level for the P2P communication.

In an embodiment, the recommended P2P channel may belong to a set of channels used by the AP for its infrastructure BSS operation. This P2P channel may be referred to as an ‘infrastructure P2P channel’ or ‘infra P2P channel’ in this disclosure. Although the P2P channel is part of the operating channels of the AP, the AP may not use the channel for its BSS operation during the channel announcement. However, the AP may use this channel at a larger stage by performing BSS channel switch operation.

In an embodiment, the recommended P2P channel may not belong to a set of channels used by the AP for its BSS operation. The P2P channel may be referred to as a ‘non-Infrastructure P2P channel’ or ‘non-Infra P2P channel.’ When the STA intending to engage in P2P communication uses the channel, the STA may not encounter interference from the infrastructure network.

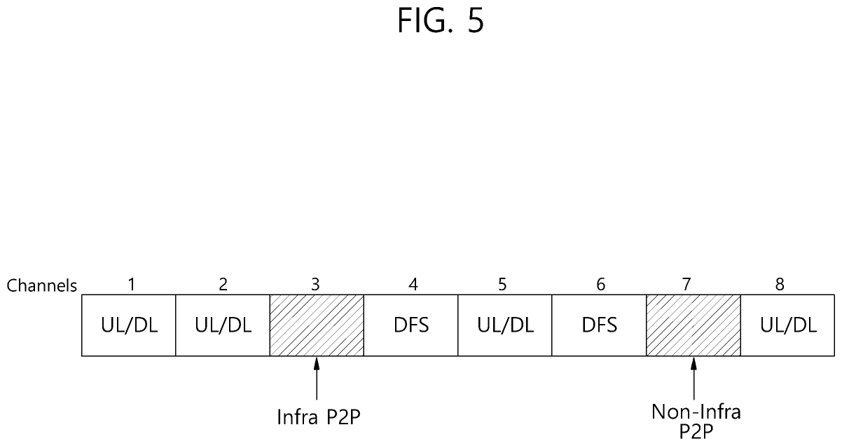

FIG. 5 shows an example of recommended P2P channels in accordance with an embodiment. The channel types depicted in FIG. 5 are for illustrative purposes only and do not limit the scope of this disclosure to any particular implementation of the recommended P2P channels.

In the example of FIG. 5, an AP has 8 available channels in its operating link from channel 1 through channel 8. Channels 1, 2, 5, and 8 are used for uplink (UL) and downlink (DL) communication by the AP, and channels 4 and 6 are DFS channels for special activities, such as radar, defense, or weather-related activities. In order to minimize the interference from P2P traffic on the UL/DL channels, the AP may recommend channels 3 and 7 for P2P communication. Channel 3 is used for infra P2P channel. It may be assigned for P2P communication, even though it is part of the AP's operating channel set. For example, a TDLS (tunneled direct link setup) peer STA may use channel 3 for TDLS channel switching, moving from a base channel to an off-channel for TDLS. In some embodiments, the off-channel may be a channel used by a TDLS STA that does not overlap the channels used by the AP with which the TDLS STA is associated, while the base channel is a primary channel of the BSS of the AP with which the TDLS STA is associated. Channel 7 is used for non-Infra P2P channel. This channel is not part of the AP's operating channel set. For example, the STA may use this channel to initiate a Wi-Fi Direct P2P group.

In an embodiment, an AP that advertises P2P channels may not differentiate between Infra P2P channels and No-Infra P2P channel. The AP may simply allocate one channel where it intends to accommodate all the P2P transmissions, regardless of whether the channel is an infra P2P channel or non-Infra P2P channel. This channel may be referred to as a ‘mixed P2P channel.

In another embodiment, another recommended P2P channel may be defined. During the time of P2P channel advertisement, the recommended P2P channel may also be being used by the AP for its infrastructure BSS. This P2P channel may be referred to as a ‘coexisting P2P channel.’ It is of particular interest for concurrent P2P devices that need to maintain simultaneous association with both an infrastructure network (e.g., for internet connectivity) and a P2P group and may prefer not to switch channels for communication between these two networks, for example, for power-saving purposes.

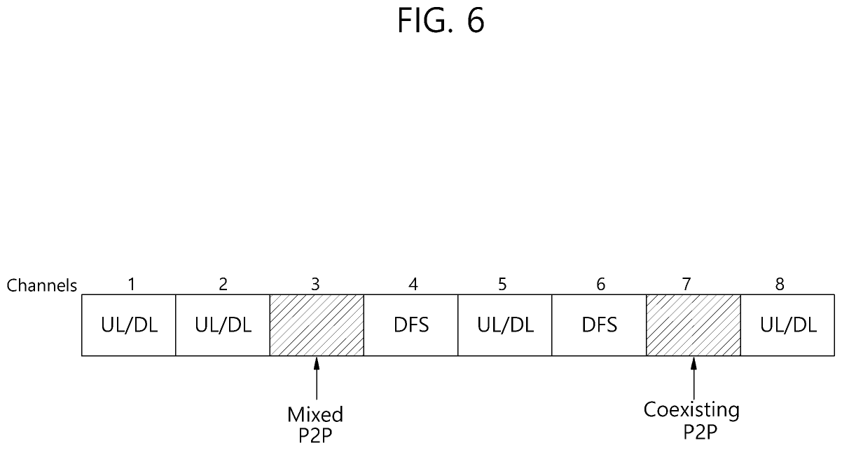

FIG. 6 shows another example of recommended P2P channels in accordance with an embodiment. The channel types depicted in FIG. 6 are for illustrative purposes only and do not limit the scope of this disclosure to any particular implementation of the recommended P2P channels.

In the example of FIG. 6, an AP has 8 available channels in its operating link from channel 1 through channel 8. Channels 1, 2, 5, and 8 are used for uplink (UL) and downlink (DL) communication by the AP, and channels 4 and 6 are DFS channels for special activities, such as radar, defense, or weather-related activities. In order to minimize the interference from P2P traffic on the UL/DL channels, the AP may recommend channels 3 and 7 for P2P communication. Channel 3 is used for mixed P2P channel and channel 7 is used for coexisting P2P channel.

In an embodiment, a STA that supports this feature and receives the recommendation or advertisement from a beacon frame or a probe response frame may not use any other channel than the recommended channel. In other words, the STA may exclusively use the recommended channels and avoid using any other channels. In another embodiment, a STA that supports this feature and receives the recommendation or advertisement from a beacon frame or a probe response frame may have the discretion to either follow or disregard the recommendation. Even if the STA supports the channel recommendation feature and receives the relevant and necessary information from the AP, the STA may opt to use another channel that is not within the set of recommended channels by the AP for P2P communication.

In an embodiment, if an AP STA or a non-AP STA supports P2P channel recommendation procedure described in this disclosure, it may set the dot11ChannelRecommendationSupported MIB variable to 1. Otherwise, it may set the dot11ChannelRecommendationSupported MIB variable to 0. In another embodiment, if an AP STA or a non-AP STA supports P2P channel recommendation procedure described in this disclosure, it may set the Channel Recommendation Supported field in the Extended Capabilities element to 1. Otherwise, it may set the Channel Recommendation Supported field in the Extended Capabilities element to 0.

In an embodiment, an AP that supports channel recommendation procedure may advertise or announce the recommended channels by including a Recommended P2P Channel Usage Info element in a beacon frame or a probe response frame.

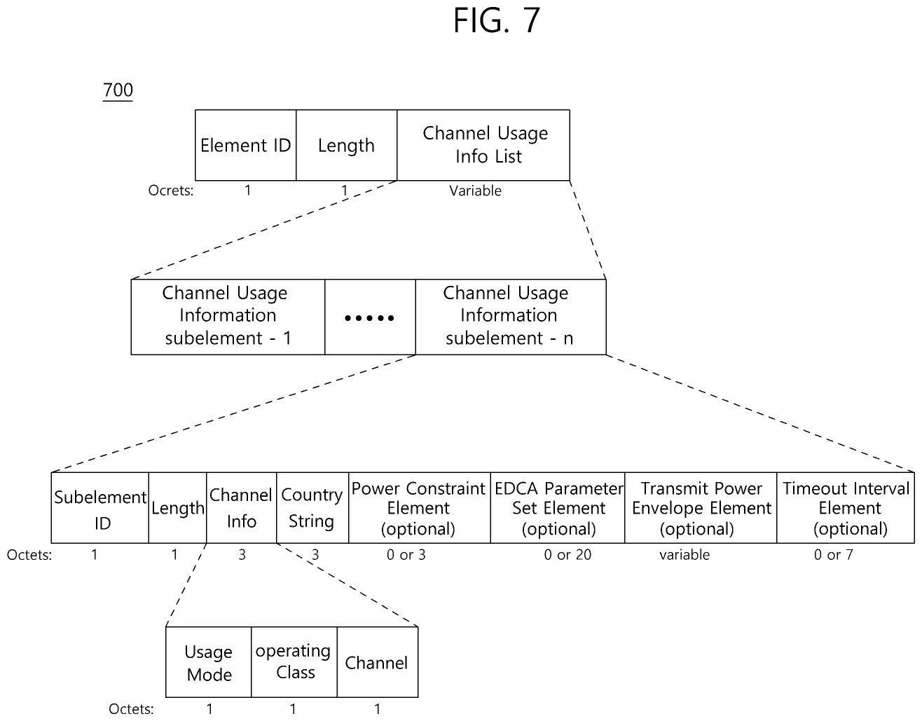

FIG. 7 shows an example of Recommended P2P Channel Usage Info element in accordance with an embodiment. The example format depicted in FIG. 7 is for explanation and illustration purposes. The example format does not limit the scope of this disclosure to any particular implementation.

Referring to FIG. 7, the Recommended P2P Channel Usage Info element 700 may include an Element ID field, a Length field, and a Channel Usage Info List field. The Element ID field may include information to identify the Recommended P2P Channel Usage Info element 700. The Length field may indicate a length of the Recommended P2P Channel Usage Info element 700. The Channel Usage Info List field may include one or more Channel Usage Information sub-elements. In some embodiments, each of Channel Usage Information subelements may be associated with a respective one of one or more recommended channels indicated by the Recommended P2P Channel Usage Info element 700. In some implementations, the number of Channel Usage Information subelements may be the same as the number of recommended channels.

One possible form of the Channel Usage Information subelement may include a Subelement ID field, a Length field, a Channel Info field, a Country String field, a Power Constraint Element field, a EDCA (Enhanced Distributed Channel Access) Parameter Set Element field, a Transmit Power Set Element field, and a Timeout Interval Element field.

The Subelement ID field may include information to identify the Channel Usage information subelement. The Length field may indicate a length of the Channel Usage information subelement.

The Channel Info field may include the recommended P2P channel related information. Specifically, the Channel Info field may include a Usage Mode field, an Operating Class field, and Channel field. The usage Mode field may include information to identify a value indicating the usage of the recommended P2P channels. Table 1 below provides an example encryption of the Usage Mode field. The Usage Mode field may be interpreted as the AP's recommendation on how to use the recommended P2P channels. The Operating Class field may indicate an operating class value. The operating class may be interpreted in the context of the country specified in the beacon frame. The Channel field may indicate a channel number which may be interpreted in the context of the indicated operating class. The channel number may indicate a recommended channel for peer-to-peer communication.

TABLE 1

| Value | Information |
|---|---|
| 1 | Infrastructure Direct Link |
| 2 | Independent BSS using Infra-channels |
| 3 | Independent BSS outside of Infra-channels |
| 4 | Infrastructure Direct Link - Latency Sensitive |
| 5 | Independent BSS using Infra-channels - Latency Sensitive |
| 6 | Independent BSS outside of Infra-channels - Latency Sensitive |
| 7-255 | Reserved |

The Country String field may be the value contained in the dot11CountryString attribute. Upon reception of this subelement, the receiving STA may set the value of the dot11CountryString to the value contained in this field.

The Power Constraint Element field may be optional. It may include zero or one Power Constraint element. The Power Constraint element may include information necessary to allow a receiving STA to determine the local maximum transmit power.

The EDCA Parameter Set Element field includes zero or one EDCA Parameter Set element. The EDCA Parameter Set element may provide information needed by receiving STA for proper operation of the QoS (Quality of Service) facility during contention period.

The Transmit Power Envelope element field may include zero or more Transmit Power Envelope elements. The Transmit Power Envelope element may provide the local or regulatory maximum transmit power for various transmission bandwidths or channels within the bandwidth of the BSS.

The Timeout Interval Element field may include zero or one Timeout Interval element. The Timeout Interval element may include information for time intervals and timeouts. The Timeout Interval element may indicate duration for which the P2P channel recommendation, as indicated in the corresponding Channel Usage Information subelement in the Recommended P2P Channel Usage Info element, remains valid.

In an embodiment, the information carried on the Power Constraint Element field, the EDCA Parameter Set Element field, the Transmit Power Envelope Element field, and the Timeout Interval Element field in the Channel Usage Information subelements are for receiving STAs. In other words, these parameters are suggested for use by the STAs if they intend to use the recommended channels in the corresponding Channel Usage Information subelements for P2P communication.

In another embodiment, the information carried on the Power Constraint Element field, the EDCA Parameter Set Element field, the Transmit Power Envelope Element field, and the Timeout Interval Element field in the Channel Usage Information subelements serves to indicate that the AP can use these parameters for the channels indicated by the corresponding Channel Usage Information subelements.

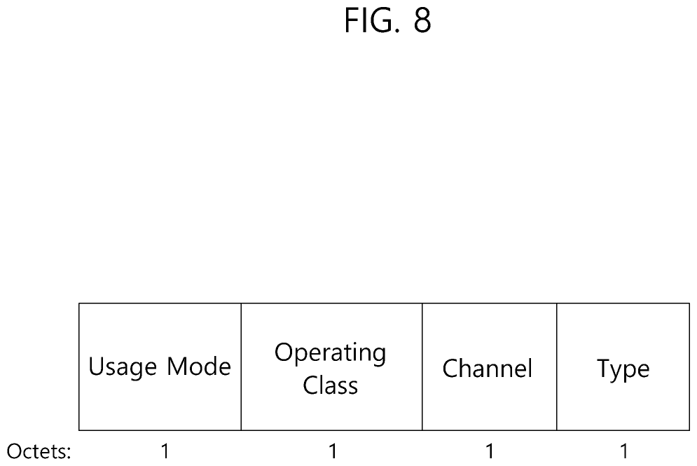

FIG. 8 shows another example format of the Channel Info field in the Channel Usage Information subelement in accordance with an embodiment.

Referring to FIG. 8, the Channel Info field may include a Usage Mode field, an Operating Class field, a Channel field, and a Type field. The various fields in the Channel Info field depicted in FIG. 8 may be the same as or similar to corresponding fields in the Channel Info field depicted in FIG. 7, except for the Type field. The Type field may indicate the recommended P2P channel type. Table 2 below provides an example encoding of the Type field. The Type subfield can be used by STAs as a measure of expected interference in the advertised P2P channel. Therefore, this formation can help STAs in deciding which recommended P2P channel to select for their P2P communication.

TABLE 2

| Value | Information |
|---|---|
| 1 | Infrastructure P2P |
| 2 | Non-Infrastructure P2P |
| 3 | Mixed P2P |
| 4 | Coexisting P2P |

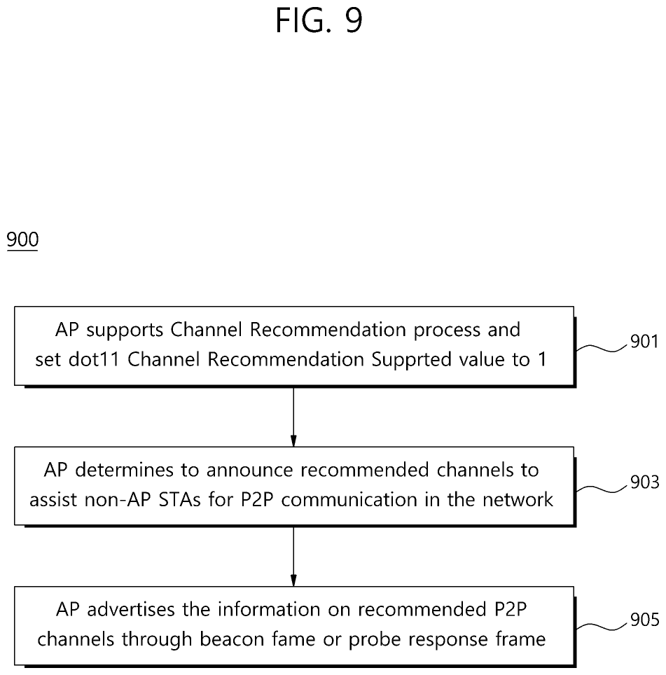

FIG. 9 shows a flow chart of an example process for channel recommendation in accordance with an embodiment. For explanatory and illustration purposes, the example process 900 may be performed by an AP 430 of FIG. 4. Although one or more operations are described or shown in particular sequential order, in other embodiments the operations may be rearranged in a different order, which may include performance of multiple operations in at least partially overlapping time periods.

The process 900 may begin in operation 901. In operation 901, the AP that supports the channel recommendation process may set the dot11ChannelRecommendationSupprted value to 1. Then, the process 900 proceeds to operation 903.

In operation 903, the AP may determine to announce or advertise recommended channels to assist non-AP STAs for P2P communication in the network. In an embodiment, the AP may assist non-AP STAs in setting up off-channel TDLS direct link or selecting bands and channels for independent BSS or P2P group. Then, the process 900 proceeds to operation 905.

In operation 905, the AP may advertise relevant information on the recommended channels for P2P communication through a beacon frame or a probe response frame. In an embodiment, the relevant information may be included in a Recommended P2P Channel Usage element depicted in FIG. 7 within the beacon frame or the probe response frame.

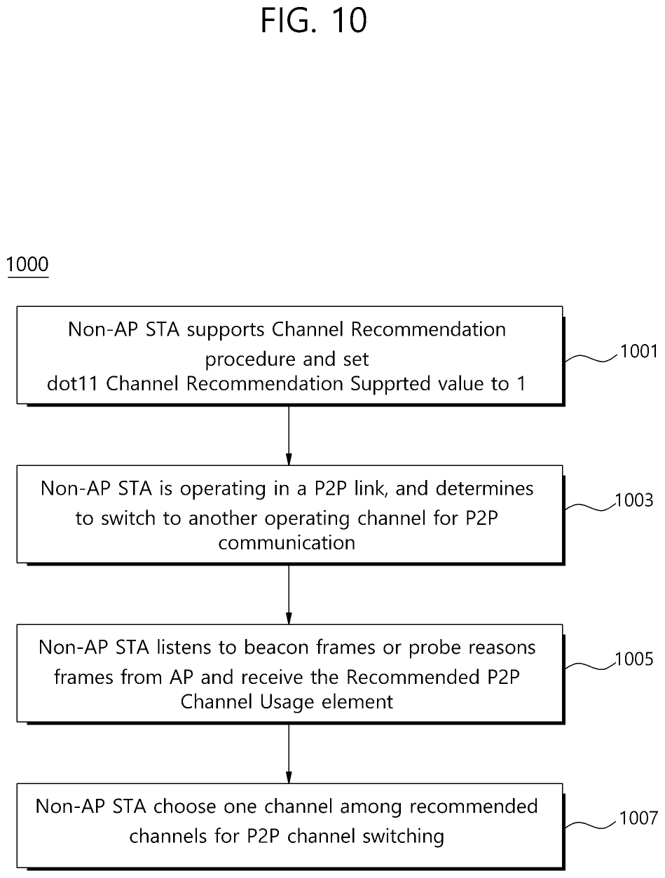

FIG. 10 shows a flow chart of an example process for channel recommendation in accordance with an embodiment. For explanatory and illustration purposes, the example process 1000 may be performed by non-AP STAs 410 of FIG. 4, particularly when the non-AP STAs intend to switch a channel for an existing P2P link. Although one or more operations are described or shown in particular sequential order, in other embodiments the operations may be rearranged in a different order, which may include performance of multiple operations in at least partially overlapping time periods.

The process 1000 may begin in operation 1001. In operation 1001, a non-AP STA that supports the Channel Recommendation process may set the dot11ChannelRecommendationSupprted value to 1. Then, the process 1000 proceeds to operation 1003.

In operation 1003, while the non-AP STA is operating on a P2P link (e.g., a base channel TDSL direct link), the non-AP STA may determine to switch to another operating channel for P2P communication (e.g., off-channel TDLS direct link). In other words, the non-AP STA may move from a base channel TDSL direct link to an off-channel TDLS direct link. Then, the process 1000 proceeds to operation 1005.

In operation 1005, the non-AP STA may listen to beacon frames or probe response frames transmitted from an AP controlling the infrastructure BSS and may receive the Recommended P2P Channel Usage element depicted in FIG. 7 within the beacon frames or the probe response frames. Then, the process 1000 proceeds to operation 1007.

In operation 1007, the non-AP STA may choose one channel among the recommended channels indicated in the Recommended P2P Channel Usage element in the beacon frames or the probe response frames and initiate channel switching for P2P communication.

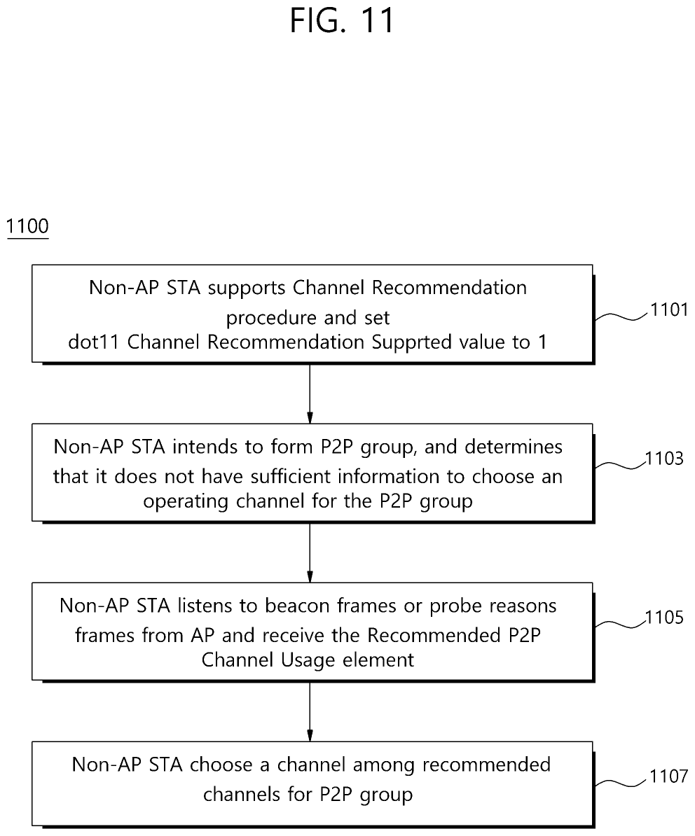

FIG. 11 shows a flow chart of an example process for channel recommendation procedure in accordance with an embodiment. For explanatory and illustration purposes, the example process 1100 may be performed by non-AP STAs 410 or 420 in FIG. 4, particularly when the non-AP STAs intend to establish a non-infrastructure P2P group. Although one or more operations are described or shown in particular sequential order, in other embodiments the operations may be rearranged in a different order, which may include performance of multiple operations in at least partially overlapping time periods.

The process 1100 may begin in operation 1101. In operation 1101, a non-AP STA that supports the channel recommendation process may set the dot11ChannelRecommendationSupprted value to 1. Then, the process 1100 proceeds to operation 1003.

In operation 1103, the non-AP STA that intends to form a P2P group may determine that it does not have sufficient information to choose an operating channel for the P2P group. Then, the process 1100 proceeds to operation 1105.

In operation 1105, the non-AP STA may listen to beacon frames or probe response frames transmitted from a nearby AP controlling the infrastructure BSS near the non-AP STA, and may receive Recommended P2P Channel Usage element depicted in FIG. 7 within the beacon frames or the probe response frames. Then, the process 1100 proceeds to operation 1107.

In operation 1107, the non-AP STA may choose a channel among recommended channels indicated in the Recommended P2P Channel Usage element in the beacon frames or the probe response frames and initiate forming P2P group to perform P2P communication.

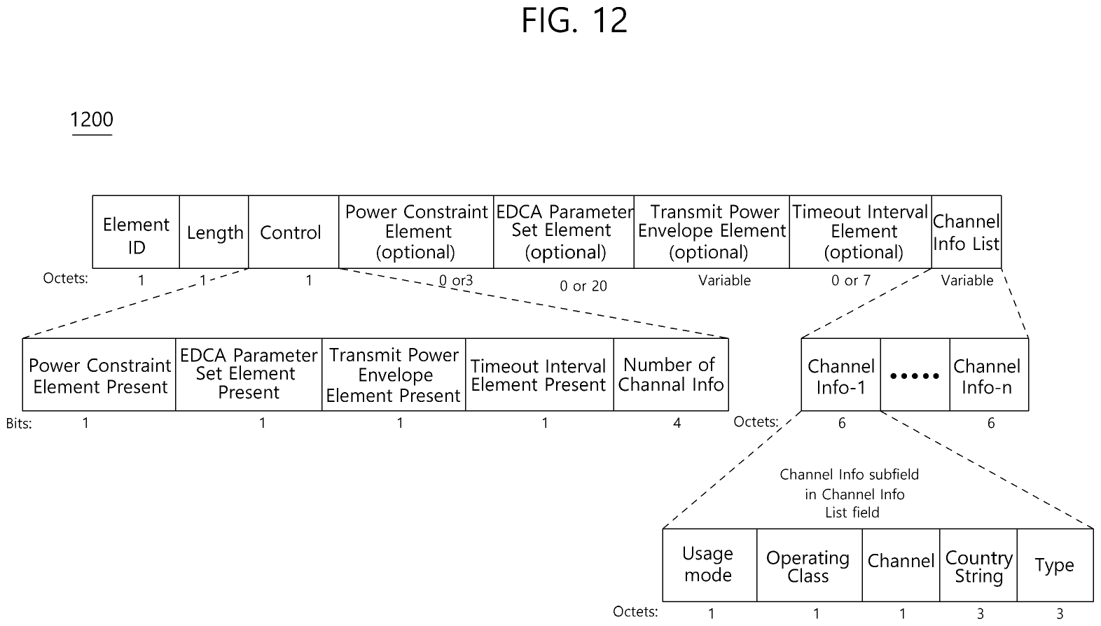

FIG. 12 shows another example of Recommended P2P Channel Usage Info element 1200 in accordance with an embodiment. The example format depicted in FIG. 12 is for illustrative purposes only. The example format does not limit the scope of this disclosure to any particular implementation.

Referring to FIG. 12, the Recommended P2P Channel Usage Info element 1200 may include an Element ID field, a Length field, a Control field, a Power Constraint Element field, a EDCA Parameter Set Element field, a Transmit Power Envelope Element field, a Timeout Interval Element field, and a Channel Info List field. In some aspects, the various fields in the Recommended P2P Channel Usage Info element 1200 depicted in FIG. 12 may be the same as or similar to corresponding fields or subfields in the Recommended P2P Channel Usage Info element 700 depicted in FIGS. 7 and 8, with examples of differences described below.

The Control field may include a Power Constraint Element Present field, a EDCA Parameter Set Element Present field, a Transmit Power Envelope Element Present field, a Timeout Interval Element Present field, and a Number of Channel Info field.

The Power Constraint Element Present field may indicate whether the Power Constraint Element field is present in the Recommended P2P Channel Usage Info element 1200. When the Power Constraint Element Present field is set to 1, it may indicate that the Power Constraint Element field is present. Otherwise, it is set to 0.

The EDCA Parameter Set Element Present field may indicate whether the EDCA Parameter Set Element field is present in the Recommended P2P Channel Usage Info element 1200. When the EDCA Parameter Set Element Present field is set to 1, it may indicate that the EDCA Parameter Set Element field is present. Otherwise, it is set to 0.

The Transmit Power Envelope Element Present field may indicate whether the Transmit Power Envelope Element field is present in the Recommended P2P Channel Usage Info element 1200. When the Transmit Power Envelope Element Present field is set to 1, it may indicate that the Transmit Power Envelope Element Present is present. Otherwise, it is set to 0.

The Timeout Interval Element Present field may indicate whether the Timeout Interval Element field is present in the Recommended P2P Channel Usage Info element 1200. When the Timeout Interval Element Present subfield is set to 1, it may indicate that the Timeout Interval Element field is present. Otherwise, it is set to 0.

The Number of Channel Info field may indicate how many channels are recommended in the Recommended P2P Channel Usage Info element 1200. In some implementations, the Number of Channel Info field may also indicate the number of Channel Info fields included in the Channel Info List field within the Recommended P2P Channel Usage Info element 1200.

The Channel Info List field may include one or more Channel info fields. Each Channel info field may include a Usage Mode field, an Operating Class field, a Channel field, a Country String field and a Type field. Those fields are same as or similar to corresponding fields or subfields in the Recommended P2P Channel Usage Info element 700 depicted in FIGS. 7 and 8.

In some embodiments, each of Channel Info fields may be associated with a respective one of one or more recommended channels indicated by the Recommended P2P Channel Usage Info element 1200. In some implementations, the number of Channel Info fields may be the same as the number of recommended channels.

In the example of FIG. 12, the Power Constraint Element field, the EDCA Parameter Set Element field, the Transmit Power Envelope Element field and the Timeout Interval Element field may be common for all recommended channels indicated by the Recommended P2P Channel Usage Info element 1200, while these fields depicted in FIG. 7 may be specific to their corresponding channels indicated by the Channel Usage Information subelements.

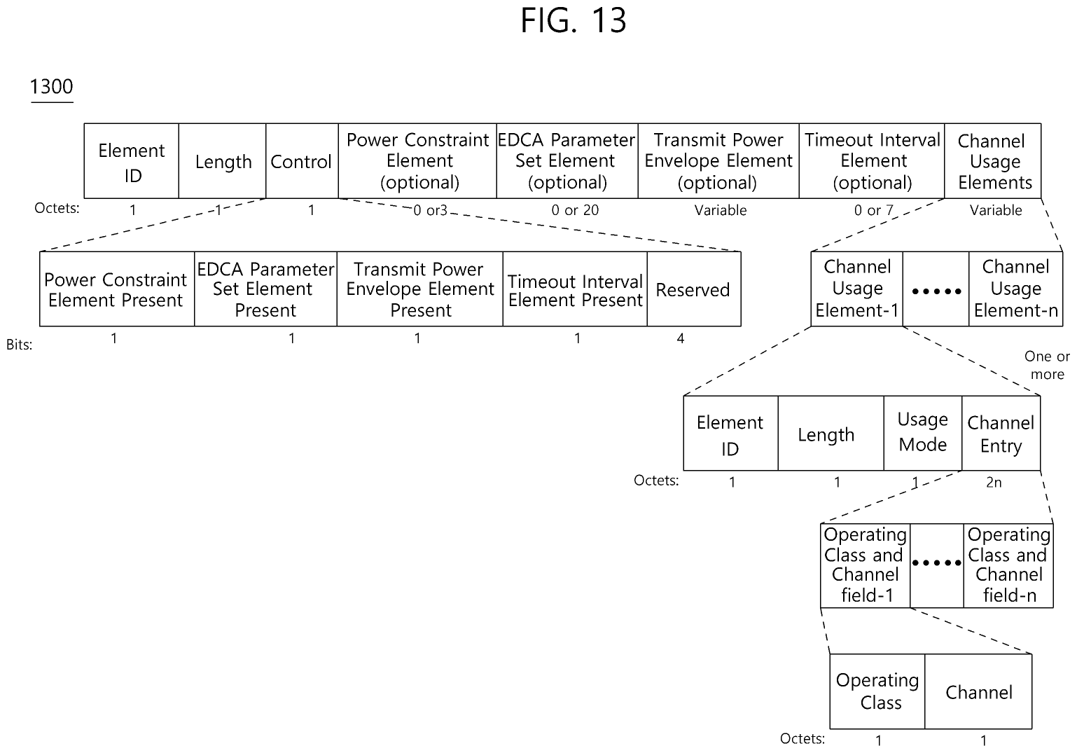

FIG. 13 shows another example of Recommended P2P Channel Usage Info element 1300 in accordance with an embodiment. The example format depicted in FIG. 13 is for illustrative purposes only. The example format does not limit the scope of this disclosure to any particular implementation.

In FIG. 13, the Recommended P2P Channel Usage Info element 1300 may include an Element ID field, a Length field, a Control field, a Power Constraint Element field, a EDCA Parameter Set Element field, a Transmit Power Envelope Element field, a Timeout Interval Element subfield, and a Channel Usage Elements field. In some aspects, the various fields and subfields in the Recommended P2P Channel Usage Info element 1300 may be the same as or similar to corresponding fields or subfields in the Recommended P2P Channel Usage Info elements 700 and 1200 depicted in FIGS. 7, 8 and 12, with examples of differences described below.

The Channel Usage Elements field may include one or more Channel Usage element subfields. Each Channel Usage Element subfield may include an Element ID field, a Length field, a Usage Mode field, and Channel Entry field.

The Element ID field may include information to identify the Channel Usage Element subfield, and the Length field may indicate a length of the Channel Usage Element subfield. The Usage Mode field may be interpreted as the AP's recommendation on how to use the recommended P2P channels. In some embodiments, the Usage Mode field may indicate the usage of the recommended channel as provided in Table 1 above.

The Channel Entry field may include one or more Operating Class and Channel fields. Each Operating Class and Channel field may include an Operating Class field and a Chanel field. The Operating Class field may indicate an operating class value. The operating class may be interpreted in the context of the country specified in the beacon frame. The Channel field may indicate a channel number which may be interpreted in the context of the indicated operating class. The channel number may indicate a recommended channel for peer-to-peer communication.

Referring to FIG. 13, the Recommended P2P Channel Usage Info element 1300 may include one or more Channel Usage element subfields, which is an example of differences from the previous examples.

In an embodiment, an AP may indicate how long the channel recommendation is valid while advertising the recommended P2P channels. This indication may be achieved by including a Timeout Interval element in the Recommended P2P Channel Usage Info element. In another embodiment, alternative mechanisms may be employed for this purpose, such as indicating the end time of the recommendation. This may include specifying TSF (timing synchronization function) value or the duration of recommendation validity, for example, with respect to the transmission time of a beacon frame or a probe response frame containing the corresponding Recommended P2P Channel Usage Info element.

In an embodiment, a first AP, affiliated with an AP MLD and operating on a first link, may advertise or announce, through a beacon frame or a probe response frame, the recommended P2P channels for a second link on which a second AP affiliated with the same AP MLD is operating.

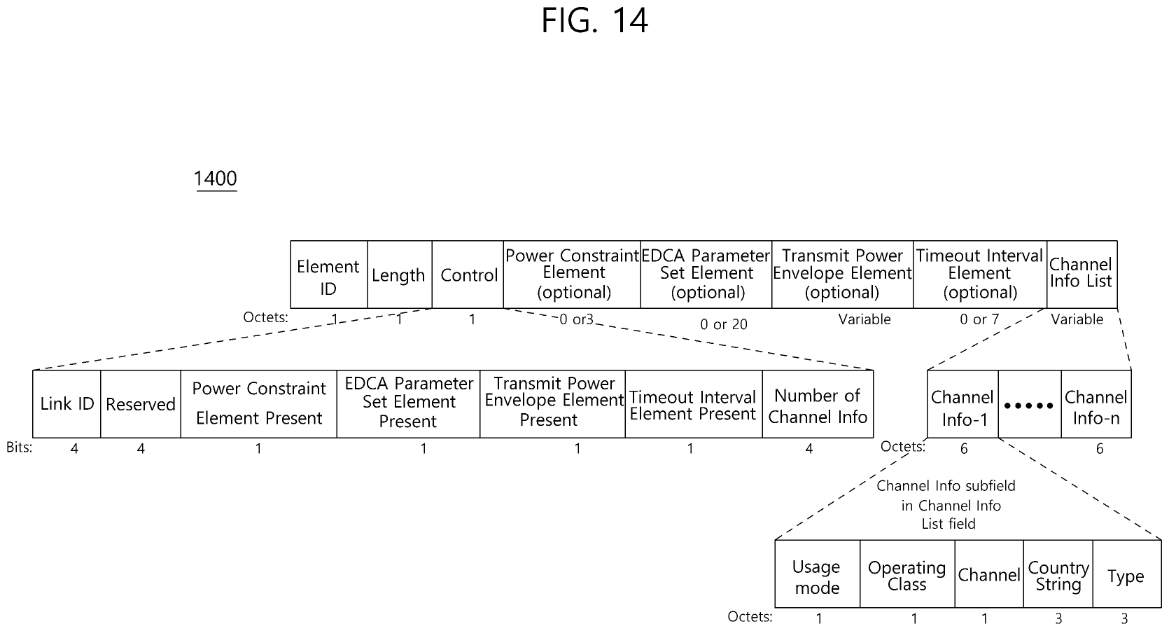

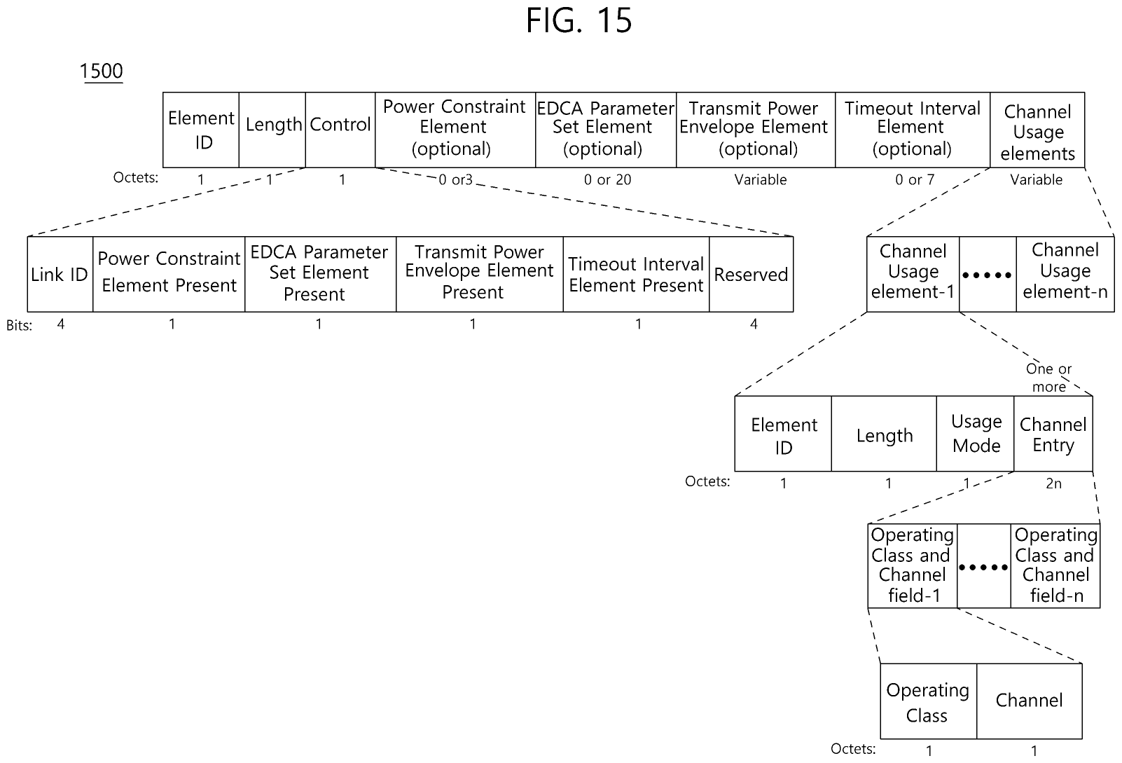

In an embodiment, when a first AP, affiliated with an AP MLD and operating on a first link, advertises or announces recommended P2P channels corresponding to another AP affiliated with the same AP MLD, the first AP may indicate the links or another AP (operating on that link) for the P2P channel recommendation. In some implementations, in order to indicate the link for the recommendation, the first AP may include a Link ID subfield in the Recommended P2P Channel Usage Info element. In some aspects, possible formats of the Recommended P2P Channel Usage Info element are shown in FIGS. 14 and 15, which are based on FIGS. 12 and 13, respectively.

FIGS. 14 and 15 show another example of Recommended P2P Channel Usage Info element 1400 and 1500 in accordance with an embodiment. The example format depicted in FIG. 14 is for illustrative purposes only. The example format does not limit the scope of this disclosure to any particular implementation. In some aspects, the various fields and subfields in the Recommended P2P Channel Usage Info element 1400 may be the same as or similar to corresponding fields or subfields in the Recommended P2P Channel Usage Info element 1200 depicted in FIG. 12, with examples of differences described below. In some aspects, the various fields or subfields in the Recommended P2P Channel Usage Info element 1500 may be the same as or similar to corresponding fields or subfields in the Recommended P2P Channel Usage Info element 1300 depicted in FIG. 13, with examples of differences described below.

Referring to FIG. 14, the Control field may further include a Link ID field and a reserved field, compared to the Control field of FIG. 12. The Link ID field indicates one or more links for the P2P channel recommendation.

Referring to FIG. 15, the Control field may further include a Link ID field and a reserved field, compared to the Control field of FIG. 13. The Link ID subfield indicates one or links for the P2P channel recommendation.

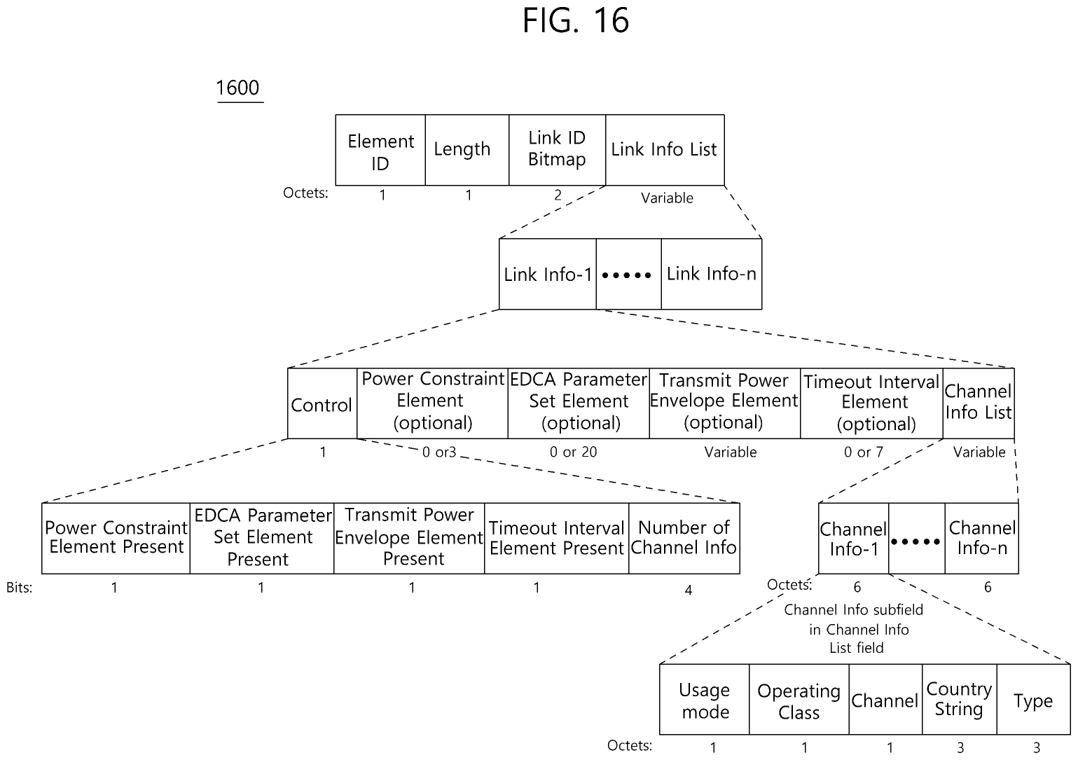

In some implementations, a link ID bitmap may be used to indicate the links for which the P2P recommended channel information is provided. A possible example is illustrated in FIG. 16.

FIG. 16 shows another example of Recommended P2P Channel Usage Info element 1600 in accordance with an embodiment. The example format depicted in FIG. 16 is for illustrative purpose only. The example format does not limit the scope of this disclosure to any particular implementation. In some aspects, various field and subfields in the Recommended P2P Channel Usage Info element 1600 may be the same as or similar to corresponding fields or subfields in the Recommended P2P Channel Usage Info elements of FIGS. 12-15, with examples of difference described below.

In FIG. 16, the Recommended P2P Channel Usage Info element 1600 may include an Element ID field, a Length field, a Link ID Bitmap field, and a Link Info List field. The Link ID Bitmap field may indicate the links for which the P2P channel recommendation is provided. If a bit position i of the Link ID Bitmap field is set to 1, it may indicate that there is P2P channel recommendation for the i-th link. Otherwise, it may indicate that there is no P2P channel recommendation for the link.

The Link Info List field may include one or more Link Info subfields. In some implementations, the number of Link Info subfields may be equal to as the number of ‘1’ value in the Link ID Bitmap field. The order to Link Info subfields corresponding to different links may be the same as the order of ‘1’ the value in the Link ID Bitmap subfield. In some implementations, when the Link ID Bitmap field is set as ‘1001010000000000’, then the first Link Info subfield may correspond to Link 1, the second Link Info subfield to Link 4, and the third Link Info subfield to Link 6.

In the example of FIG. 16, each Link Info List subfield may include a control field, a Power Constraint Element field, a EDCA Parameter Set Element field, a Transmit Power Envelope Element field, a Timeout Interval Element field, and a channel Info List field.

In some embodiments, as an alternative frame format to that shown in FIG. 16, the Control field may be positioned in parallel with the Link ID Bitmap subfield. In some embodiments, the Power Constraint Element field, the EDCA Parameter Set Element field, the Transmit Power Envelope Element field, and the Timeout Interval Element field may be common for channel recommendation for all the links whose information is carried in the Recommended P2P Channel Usage Info element.

In some embodiments, the P2P channel recommendation information, such as the information carried in the Recommended P2P Channel Usage Info element, may be encrypted as unprotected in a beacon frame or a probe response frame. This would allow the STA not associated with the AP to still scan the beacon or probe response frame and extract the channel recommendation information.

In some embodiments, after receiving channel recommendation information from the AP, if a non-AP STA determines that none of the recommended channels is suitable for P2P communication purpose, the non-AP STA can request the AP to modify the recommendation by sending a message. This modification may involve opening up or allocating a new channel for P2P communication. Upon receiving the request from the non-AP STA, the AP can decide whether to allocate a new channel for P2P communication or perform load balancing within the existing channels. Otherwise, the AP may disregard the modification request. In some embodiments, the AP may respect the request if the AP receives such request from at least a threshold number of non-AP STAs in the network.

In some embodiments, an AP, affiliated with an NSTR (Non-Simultaneous Transmit and Receive) Mobile AP MLD and operating on the primary link, may advertise the recommended P2P channels on behalf of the other AP affiliated with the same NSTR Mobile AP MLD and operating on the non-primary link.

In some embodiments, a first AP operating in a first BSS may determine the recommended P2P channels in coordination with nearby APs operating in other BSS in a multi-AP coordination form. Alternatively, the first AP may coordinate channel selection with other APs operating under the same ESS (Extended Service Set). This means that a centralized controller controlling the APs in the ESS may evaluate the entire enterprise network condition and decide on the recommended channels accordingly.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP) device in a wireless network, the AP device comprising:
a memory; and
a processor coupled to the memory, the processor configured to:
generate a frame indicating one or more recommended channels for peer-to-peer communication; and
transmit the frame to one or more non-AP devices.

2. The AP device of claim 1, wherein the frame is a beacon frame or a probe response frame.

3. The AP device of claim 1, wherein the frame includes a channel usage element for the one or more recommended channels.

4. The AP device of claim 3, wherein the channel usage element includes a usage mode field indicating a usage of the one or more recommended channels.

5. The AP device of claim 3, wherein the channel usage element includes one or more channel numbers and one or more operating classes for the one or more recommended channels.

6. The AP device of claim 1, wherein a non-AP device among the one or more non-AP device is unassociated with the AP device.

7. The AP device of claim 1, wherein the frame includes a power constraint element indicating a maximum transmit power for a receiving non-AP device.

8. The AP device of claim 1, wherein the frame includes an enhanced distributed channel Access (EDCA) parameter set element indicating EDCA parameters for transmission for a receiving non-AP device.

9. The AP device of claim 1, wherein the one or more recommended channels are within a set of channels used by the AP device for infrastructure basic service set.

10. The AP device of claim 1, wherein the one or more recommended channels are outside a set of channels used by the AP device for infrastructure basic service set.

11. A non-access point (AP) device in a wireless network, the non-AP device comprising:
a memory; and
a processor coupled to the memory, the processor configured to:
receive a frame indicating one or more recommended channels for peer-to-peer communication from an AP device;
select a channel among the one or more recommended channels for peer-to-peer communication based on the received frame; and
perform peer-to-peer communication with one or more other non-AP devices using the selected channel.

12. The non-AP device of claim 11, wherein the frame is a beacon frame or a probe response frame.

13. The non-AP device of claim 11, wherein the frame includes a channel usage element for the one or more recommended channels.

14. The non-AP device of claim 13, wherein the channel usage element includes a usage mode field indicating a usage of the one or more recommended channels.

15. The non-AP device of claim 13, wherein the channel usage element includes one or more channel numbers and one or more operating classes for the one or more recommended channels.

16. The non-AP device of claim 11, wherein the AP device is unassociated with the non-AP device.

17. The non-AP device of claim 11, wherein:
the frame includes a power constraint element; and
the processor is further configured to determine a maximum transmit power based on the power constraint element.

18. The non-AP device of claim 11, wherein:
the frame includes an enhanced distributed channel Access (EDCA) parameter set element; and
the processor is further configured to determine EDCA parameters for transmission based on the EDCA parameter element.

19. The non-AP device of claim 11, wherein the one or more recommended channels are within a set of channels used by the AP device for infrastructure basic service set.

20. The non-AP device of claim 11, wherein the one or more recommended channels are outside a set of channels used by the AP device for infrastructure basic service set.
